(19) United States
(12) Patent Application Publication
(10) Pub. No.: US 2007/0114142 A1
(43) Pub. Date: May 24, 2007

(54) Container with perfuming means

(75) Inventors: Mark Richard Sine, New Richmond, OH (US); Chitra Laxmanan, Cincinnati, OH (US); Ayub Ibrahim Khan, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/591,117

(22) Filed: Nov. 1, 2006

Related U.S. Application Data
(60) Provisional application No. 60/732,311, filed on Nov. 1, 2005.

(51) Int. Cl. B65D 81/24; B65D 69/00; B43K 19/00; G01F 11/00

(52) U.S. Cl. 206/210; 401/49; 222/390; 206/581

(57) ABSTRACT

Containers for personal care compositions, comprising perfuming means are provided. The perfuming means provides for an improved consumer scent experience upon opening the container. The perfuming means allows for greater formulation flexibility with regard to fragrances.

### CROSS REFERENCE TO RELATED APPLICATIONS

This application claims the benefit of U.S. Provisional application Ser. No. 60/732,311, filed on Nov. 1, 2005.

### FIELD OF THE INVENTION

This invention relates to containers and in particular to containers with a perfuming means located within the container. Such containers are particularly suitable for storing and delivering personal care compositions, more specifically shampoos, conditioners, body washes, antiperspirants and deodorants, color cosmetics and hair styling compositions etc.

### BACKGROUND OF THE INVENTION

Scent is one of the key factors used by consumers when selecting personal care products. It is a common practice for consumers to open personal care products to smell the fragrance of the product on the store shelf before deciding to purchase. The quality or impression of this scent experience often leads to an immediate decision on whether or not to purchase a product. Traditionally fragrance release from the product matrix itself is the sole source of fragrance experienced by the consumer when opening the cap. Sometimes, either because of the small orifice used to dispense the personal care composition or safety films used under caps to protect the integrity of the product, for example, to protect antiperspirants on the store shelf, the scent of the product is not readily apparent just by opening the cap of the container. Additionally, it is often difficult to deliver adequate fragrance to the headspace of the container while also providing sufficient perfume to provide a pleasant in use experience.

Therefore, it would be advantageous to provide personal care products wherein the scent of the product is more easily detectable by the consumer at the point of sale and during use. One attempt to provide such an experience has been the use of “scratch and sniff” devices placed on the outside of product containers. There are several drawbacks to this approach. First, depending upon the strength of the perfume used, these devices have the undesirable effect of overwhelming the aisles in which they are located. This results in a mixture of scents that can alter the perception of the scent of the selected product which is also undesirable. Secondly, once the device has been scratched numerous times its appearance becomes worn which is objectionable to the consumer. Repeated use also results in decreased efficacy. Additionally, consumers do not have confidence in these devices as an accurate portrayal of the scent of the product and still tend toward opening the cap to determine the actual scent. Further, another need not met by the “scratch and sniff” method or other attempts to provide a fragrance indication on the outside of the package is the ability to provide long lasting in use scent every time the product package is opened. This is advantageous from both the point of view of providing an accurate portrayal of the scent of the product in store as well as providing a prolonged and/or more intense fragrance experience throughout use of the product. Devices placed on the outside of packages are also not adequate to be used as a masking agent in products wherein the neat product odor is not pleasing to the consumer.

Attempts at providing headspace perfuming means inside container closers have also not met the aforementioned needs. In the art of consumer products, product aesthetics is very important to consumer acceptance. Previous attempts to provide perfumed caps have resulted in cumbersome, costly and aesthetically unattractive executions as well as not adequately meeting the needs of either manufacturers or consumers. Additionally, products are entering the market wherein stability requires little or no headspace in the container on the store shelf. This lack of headspace greatly reduces the perfume experience available to the consumer in the store.

One object of the present invention therefore is to provide a container comprising a perfuming means located within the container which provides an improved consumer experience of the scent of the product when the container is opened. Another object of the present invention is to provide a perfuming means that is either aesthetically pleasing to the consumer or alternatively not visually perceived by the consumer as a perfuming means and instead simply as part of the container within which it is placed. An additional object of the present invention is to provide a perfuming means for containers wherein there is little or no headspace. Further another object of the present invention is to provide a scent experience without the consumer having to squeeze or manipulate the container and disrupt the product contained therein.

Another object of the present invention is to provide formulation flexibility to allow perfumes of different character to be paired together to provide a better overall fragrance experience to the consumer. It is also an object of the present invention to provide a low cost fragrance alternative allowing delivery of the same perfume impact which currently requires several more times fragrance to achieve if delivered via the neat product alone.

### SUMMARY OF THE INVENTION

In view of the aforementioned unmet needs the present invention provides a container for a personal care composition comprising a perfuming means located within said container for the delivery of fragrance upon opening of said container. More specifically the present invention provides for a perfuming means selected from the group consisting of perfumed polymeric resins, perfumed hot melt adhesives, perfumed labels, perfumed cellulosic polymers, perfumed coatings and thickened perfumes.

In another embodiment the container of the present invention is fitted with a closure comprising the perfuming means as defined above.

### BRIEF DESCRIPTION OF THE DRAWINGS

FIG. 1. shows a preferred embodiment of a perfuming means formed from a polymeric resin.

FIG. 2. shows the perfuming means from FIG. 1. when inserted in a container closure.

FIG. 3. shows an alternative embodiment of a perfuming means.

### DETAILED DESCRIPTION OF THE INVENTION

While the specification concludes with claims that particularly point out and distinctly claim the invention, it is believed the present invention will be better understood from the following description.

Applicants have discovered that consumer acceptance of certain personal care products can be greatly enhanced by providing a more easily discernable and more accurate representation of the fragrance of a product on the store shelf. Additionally it has been discovered that it is possible to deliver both excellent scent impression on the shelf and during use of the product by including perfumes of different character or formulation at each point of delivery. For example a perfume which provides substantial bloom in use may not provide enough headspace fragrance. In this instance a more volatile version of the fragrance could be added via the perfuming means to provide this benefit. It is also possible to mask unpleasant neat product odor without adding additional perfumes to the product itself. The present invention also contemplates the possibility of combining two or more complimentary scents (i.e. chocolate & vanilla) using the perfuming means as described herein.

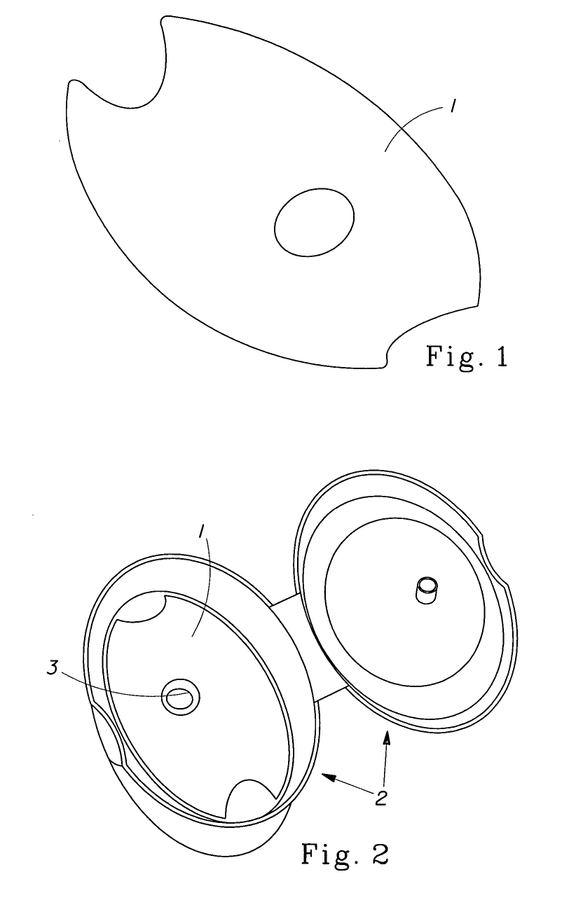

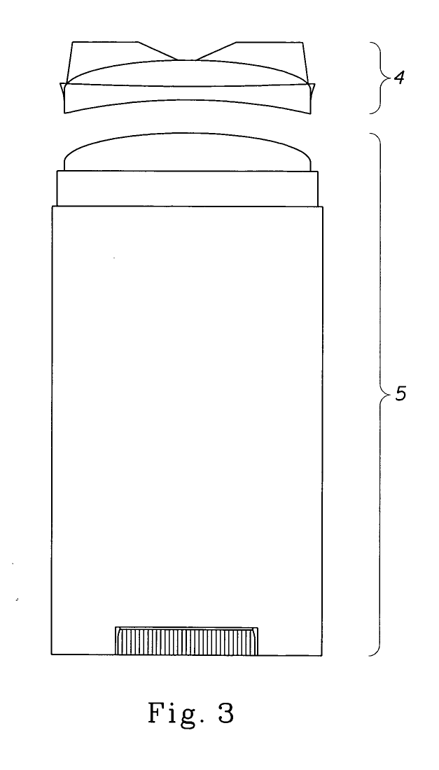

The containers of the present invention include a perfuming means located within said container. “Within said container” for the purposes of this application shall have the meaning of the space within and/or under the cap or closure. Referring now to FIGS. 1 and 2, the perfuming means (1) is formed from a polymeric resin. In FIG. 2, perfuming means (1) is fitted into closure (2) by way of a friction fit around orifice (3). Perfuming means (1) may be colored the same as or differently than closure (2). Perfuming means (1) may take the form of or include words and/or graphics as well.

All percentages are by weight of total composition unless specifically stated otherwise. All ratios are weight ratios unless specifically stated otherwise. Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”

Herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

As used herein, the term “closure” is intended to include any form of closure for an opening of a container, especially various kinds of caps which include screw caps, pushon caps, composite caps having a retractable pouring spout and the like. Also, the invention is applicable to any type of container, though containers having mouth-like openings, e.g. bottles, are particularly applicable. Other types of containers however, for example tubes, cans or cartons, and aerosol containers are also within the scope of applicability of the present invention. The invention is not limited in its application to containers for liquids, although these may be preferred. Containers for solid and semi-solid products as well as liquid products are also within the scope of the present invention.

Also as used herein, the term “headspace” generally means that region of the interior of the container above the level of any product contained therein. It is to be understood, however, that this term also encompasses the situation where what is defined as the “headspace” is a closed void formed beneath the closure cap, which does not necessarily extend as far into the container as the level of a product within it.

Perfuming Means

Materials:

In accordance with the present invention, the containers herein comprise a perfuming means located within the container. The perfuming means can be formed from any material that is compatible with the product stored within the container and the container itself, can be loaded with perfume and retains its ability to deliver fragrance for at least three months under normal transport and storage conditions, including the perfume itself.

Any thermoplastic resin material compatible with the perfume and the product stored in the container may be used. In some preferred embodiments, the perfuming means is formed from a perfumed polymeric resin. Materials suitable for use as the perfuming means include but are not limited to ethyl vinyl alcohol (EVA), high density polyethylene (HDPE), low density polyethylene (LDPE), polypropylene (PP), polyethylene terephthalate (PET) synthetic rubber/leather, latex, TPE, polystyrene, PETG, polyolefins, ethylene methyl acrylic acid, ethylene acrylic acid, metalocene, polyethylene comethyl acrylic acid, nylon, polyvinyl chloride, polycarbonate, acrylonitrile, polyether block amide etc. Other materials suitable for use include but are not limited to perfumed hot melt adhesives, perfumed labels, perfumed cellulosic polymers, perfumes thickened with any conventional thickeners, i.e. Polyamides (eg., Arizona chemical A200V), ethyl cellulose, microcrystaline waxes, particulate thickening (eg. silica, calcium silicate, calcium carbonate and the hydrophobically modified versions of these particulates, and styrene-butadiene-styrene block polymers, styrene-isoprene-styrene block copolymers (sold under the Kraton polymer trade name).

The present invention also contemplates wherein the perfume itself is the material and is simply coated or sprayed on the interior of a container or container closure.

Forms:

The perfuming means of the present invention may take many forms. It can be an injection molded part attached to or fitted into the container or closure of the container. It can also be molded directly into the container or closure as part of a two step injection molding process. Other forms contemplated include but are not limited to labels either applied with an adhesive or molded into the container as well as liners placed within the closure of the container. All perfuming means may be shaped to express an additional message to the consumer for example by way of words or images that convey the name of the product or relay a scent message as well.

The perfuming means of the present invention may be included within an antiperspirant/deodorant container. Such perfuming means provides a blooming and readily available fragrance to aid a consumer in selecting the desired fragrance of their product. Many consumers remove the cap of antiperspirant/deodorant products in order to detect the fragrance. Because the product is often protected by such means as factory seals, foils or other protective means, the consumer may tend to damage the product by removing the protective means in order to detect the scent or the consumer may be forced to guess the scent of the product. The perfuming means of the present invention provides an advantage by providing the consumer with a readily available fragrance directly under the cap to avoid removal of the protecting means or avoidance of experimental guessing. Antiperspirant/deodorant products may comprise a perfuming means located in an area under the cap or other closing means of the container. For example, the antiperspirant/deodorant container may comprise a perfuming means on or as the seal of the antiperspirant/deodorant product. The container may also comprise a perfuming means molded into the dispensing means of the antiperspirant/deodorant product such as mesh caps often used with semi-solid antiperspirant/deodorant compositions. The perfuming means may also be attached to the cap via molding, glue, hot-melt process or other attaching means. The perfuming means may also be in the form of an o-ring such that the o-ring can be formed around the neck of the product container. For example, a roll-on antiperspirant/deodorant container may comprise an o-ring perfuming means around the roll-on of such product. An aerosol product may comprise such perfuming means around the dispensing valve of the product. Regardless of the product form, the perfuming means of the present invention may be located in any position under the cap or closing means of an antiperspirant/deodorant product to provide a blooming fragrance and aid a consumer in selecting their desired scent.

The perfuming means may also take the form of a thin layer applied to the interior of a closure or portion of the container covered by a closure such that when the closure is opened or removed the scent is released. In the case of color cosmetics it may be desirable to provide a masking fragrance within said closure rather than adding it directly to the product.

Perfumes:

Any perfume can be used to scent the perfuming means. The selection of the perfume will be dependent upon the application of the invention. The amount of perfume loading on any particular perfuming means depends upon the specific application intended and the type of perfuming means selected but is contemplated to range from about 0.1% to about 100% by weight of the perfuming means. More particularly the amount of perfume is from about 0.1% to about 75%, even more particularly from about 5% to about 50% by weight of the perfuming means. In the situation wherein the perfume itself serves as the perfuming means the concentration of perfume in the perfuming means can be as great as 100%. The perfume used in the perfuming means can be the same as, similar to, complimentary to, or completely different from the perfume, if any, of the neat product.

One method of incorporating the perfume, when the perfuming means chosen is a polymeric resin, is by compounding the resin and the perfume. In this method the resin is melted and perfume is added as a liquid to the melted resin. The mixture is then extruded into a water bath for cooling then subsequently fed into a pelletizer where it is chopped into pellets. The fragranced pellets are then fed into an injection machine and molded into the desired shape. This is however, just one acceptable method and it is understood by those of skill in the art that any other conventional method for impregnating the perfuming means is suitable for use in the present invention.

The benefit achieved by the present invention can be demonstrated using a simple consumer test as detailed below. Panelists were asked to sniff a set of compositions perfumed at different levels with a scent previously determined pleasing to them and were asked to evaluate each level for overall scent intensity using a 5 point scale (+2 to −2) (+2=Much too strong, +1=Too strong, 0=Just Right, −1=Too Weak, −2=Much too weak). The goal is to provide a scent experience that provides as close to a 0 score as possible.

In a 400 g bottle of body wash, four perfumes were each tested at levels of 0.5%, 1.0%, 2.0% and 4.0% in a conventional package not having a perfuming means. All four perfumes were also tested at a level of 0.875% in the body wash+0.125% (overall 1% perfume by weight of product) in a perfuming means in accordance with the present invention.

| | | | PERFUMING MEANS | | |
|---|---|---|---|---|---|
| | | | | Weight of | |
| TOTAL | | | | perfume | |
| Total % | | CONTAINER | | in | % Perfume |
| Perfume | Total weight | CLOSURE | Total weight of | perfuming | loading in |
| (Product + perfuming | perfume (g) | % Perfume in | perfuming | means | perfuming |
| means) | (Product + Cap) | cap | means (g) | (g) | means |
| 0.5% | 2 | N/A | N/A | N/A | N/A |
| 1% | 4 | N/A | N/A | N/A | N/A |
| 2% | 8 | N/A | N/A | N/A | N/A |
| 4% | 16 | N/A | N/A | N/A | N/A |
| 1% | 4 | 0.125% | 2.5 g | 0.5 g | 20% |
| (0.875 in | | | | | |
| product + 0.125% | | | | | |
| in | | | | | |
| perfuming | | | | | |
| means) | | | | | |

As the results below show, products having as much as 4% perfume added to the body wash product still register in the lower range on the intensity scale. In contrast, products containing only 0.875% perfume in the composition but packaged in a container comprising a cap containing a perfuming means in accordance with the present invention have a much better intensity score with an overall perfume content that is much less. Perfume C in the graph below actually has a (0) score indicating the perfect amount of scent with only 1% overall perfume whereas 4% of the same perfume added only to the product results in scores of too weak.

[image]

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container for a personal care product said container comprising a perfuming means located within said container for delivery of fragrance upon opening of said container wherein said perfuming means is selected from the group consisting of perfumed polymeric resins, perfumed adhesives, perfumed labels, perfumed cellulosic polymers, thickened perfumes, and perfumed coatings.

2. A container according to claim 1 wherein said perfuming means contains from about 0.1% to about 100% perfume by weight of the perfuming means.

3. A container according to claim 1 wherein said perfuming means contains from about 0.1% to about 75% perfume by weight of the perfuming means.

4. A container according to claim 1 wherein said perfuming means is a polymeric resin.

5. A container according to claim 2 wherein said polymeric resin is selected from the group consisting of EVA, LDPE, HDPE, PET, PETG and mixtures thereof.

6. A container according to claim 4 wherein said polymeric resin is compounded with from about 0.1% to about 75% perfume by weight of said polymeric resin.

7. A container according to claim 4 wherein said polymeric resin is injection molded into an insert designed to be placed within a closure for said container.

8. A container according to claim 4 wherein said polymeric resin is injection molded as part of the container or closure for said container.

9. A container according to claim 7 wherein the injection molded insert is friction fitted into the closure.

10. A container according to claim 1 wherein said perfuming means is not visually perceptible as a perfuming means by a consumer upon opening said container.

11. A container according to claim 1 wherein the personal care product is selected from the group consisting of shampoos, conditioners, body washes, skin creams, anti-perspirants, deodorants, color cosmetics, shaving creams and lotions, hair colorants and hair styling compositions.

12. A container according to claim 1 wherein the personal care product comprises a perfume having characteristics perceived as complimentary to that in the perfuming means.

13. A container according to claim 1 wherein the personal care product comprises a perfume having characteristics perceived as different to that in the perfuming means.

14. A container according to claim 1 wherein the personal care product comprises a perfume having characteristics perceived as the same as that in the perfuming means.

15. A method of perfuming a container, comprising fitting the container with a closure comprising a perfuming means for delivery of fragrance upon opening of said container wherein said perfuming means is selected from the group consisting of perfumed polymeric resins, perfumed hot melt adhesives, perfumed labels, perfumed cellulosic polymers, thickened perfumes, and perfumed coatings.

16. A method according to claim 15 wherein said closure comprises a flip open top which is easily opened and re-closed multiple times.

17. A container for a personal care product said container comprising a perfuming means located within said container for delivery of fragrance upon opening of said container wherein said perfuming means is not visually perceptible as a perfuming means by a consumer upon opening said container.

18. A method of improving consumer purchase intent of a personal care product said method comprising the steps of a) providing a personal care product in a container, b) providing an in-store scent experience that communicates to the consumer the scent of the product within said container; wherein said scent experience is provided via a perfuming means located within said container.
